(19) United States
(12) Patent Application Publication
(10) Pub. No.: US 2025/0389955 A1
(43) Pub. Date: Dec. 25, 2025

(54) MIRROR AND HEAD-UP DISPLAY APPARATUS

(71) Applicant: Nippon Seiki Co., Ltd., Niigata (JP)

(72) Inventors: Akitoshi Koshiba, Niigata (JP); Hiroyuki Furusawa, Niigata (JP); Akiko Hatakeyama, Niigata (JP)

(21) Appl. No.: 19/217,275

(22) Filed: May 23, 2025

(30) Foreign Application Priority Data
Jun. 20, 2024 (JP) 2024-099328

(51) Int. Cl. G02B 27/01; B60K 35/23; G02B 5/08; G02B 5/10

(52) U.S. Cl. CPC G02B 27/0101; B60K 35/23; G02B 5/0841; G02B 5/10; G02B 27/0149; B60K 2360/167; G02B 2027/013; G02B 2027/0154

(57) ABSTRACT

To provide a mirror and a head-up display apparatus which can be manufactured more easily with high shape accuracy. A mirror reflects display light L and has a reflective curved surface forming a curved surface. The mirror includes: a base material with an attachment surface forming a curved surface; a mirror film that forms the reflective curved surface in a state of being bonded to the attachment surface; and reference protrusions 24a, 24b, and 24c formed to protrude around the base material. The reference protrusions 24a, 24b, and 24c each includes an upper surface and a side surface. The upper surfaces of the reference protrusions 24a and 24b are located on a same plane Pxz. The side surfaces of the reference protrusions 24a and 24c are located on a same plane Pyz. The planes Pxz and Pyz are virtual planes orthogonal to each other.

### TECHNICAL FIELD

The present disclosure relates to a mirror unit and a head-up display apparatus.

### BACKGROUND ART

A head-up display apparatus described in Patent Document 1 includes an illumination device, a display unit that is illuminated by the illumination device and emits display light, and a reflecting mirror that reflects the display light. The reflecting mirror includes a reflective layer bonded to a base material, and the reflective layer is a reflective polarizing multilayer film that reflects only a specific polarized component of visible light. The reflective polarizing multilayer film transmits infrared light of external light such as sunlight incident from outside to prevent the infrared light from reaching a TFT panel unit, and can improve heat resistance of the head-up display apparatus.

A head-up display apparatus described in Patent Document 2 includes a first mirror as a folding mirror that reflects display light emitted from a display unit in such a way as to fold the display light toward a second mirror. The folding mirror has a reflective curved surface having a curvature that causes the reflected display light to cross vertically before reaching the second mirror.

### PRIOR ART DOCUMENT

### Patent Document

Patent Document 1: PCT International Publication No. WO 2020/246546

Patent Document 2: Japanese Unexamined Patent Publication No. 2016-103008

### SUMMARY OF INVENTION

### Technical Problem

The reflective polarizing multilayer film described in Patent Document 1 is generally formed on a flat surface of a base material by vapor deposition. However, it is difficult to form a reflective polarizing multilayer film with high shape accuracy on a curved surface by vapor deposition, as described in Patent Document 2, and there has been a demand for simpler manufacturing with high shape accuracy.

The present disclosure has been made in view of the above circumstances, and it is an object of the present disclosure to provide a mirror and a head-up display apparatus that can be manufactured more easily with high shape accuracy.

### Solution to Problem

In order to achieve the above object, a mirror according to a first aspect of the present disclosure is a mirror having a reflective curved surface that reflects display light, the mirror including: a base material with an attachment surface forming a curved surface; a mirror film that forms the reflective curved surface in a state of being bonded to the attachment surface; and first to third reference protrusions formed to protrude around the base material, in which the first to third reference protrusions each includes a first surface and a second surface, the first surfaces of the first and second reference protrusions are located on the same first plane, the second surfaces of the first and third reference protrusions are located on the same second plane, and the first and second planes are virtual planes orthogonal to each other.

In order to achieve the above object, a head-up display apparatus according to a second aspect of the present disclosure includes the mirror and a display device that radiates the display light to the mirror.

### ADVANTAGEOUS EFFECTS OF INVENTION

According to the present disclosure, the mirror and the head-up display apparatus can be manufactured more easily with high shape accuracy.

### BRIEF DESCRIPTION OF DRAWINGS

FIG. 1 is a schematic diagram of a vehicle on which a head-up display apparatus according to an embodiment of the present disclosure is mounted.

FIG. 2 is a schematic diagram illustrating a configuration of a head-up display apparatus according to an embodiment of the present disclosure.

FIG. 3 is a perspective view of a mirror according to an embodiment of the present disclosure.

FIG. 4 is a front view of a mirror according to an embodiment of the present disclosure.

FIG. 5 is a side view of a mirror according to an embodiment of the present disclosure.

FIG. 6 is a perspective view of a mirror according to an embodiment of the present disclosure.

FIG. 7 is a cross-sectional view of a mirror film, a base material body portion, and a transparent adhesive layer according to an embodiment of the present disclosure.

FIG. 8 is a perspective view of a contoured mirror base material according to an embodiment of the present disclosure.

FIG. 9 is a perspective view of a mirror according to a modification of the present disclosure.

### DESCRIPTION OF EMBODIMENTS

A mirror and a head-up display apparatus according to an embodiment of the present disclosure will be described with reference to the drawings.

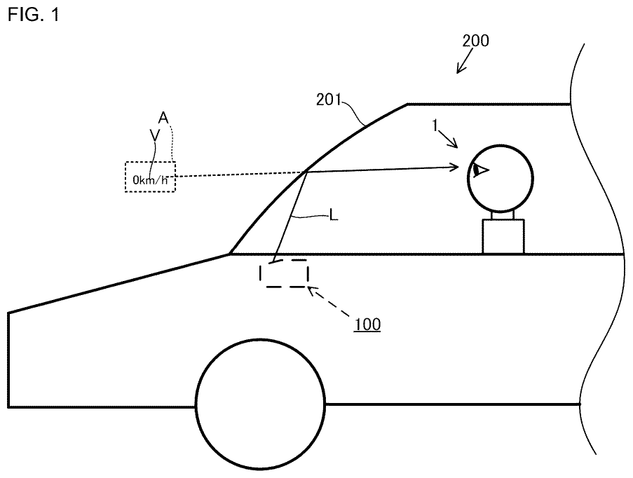

As illustrated in FIG. 1, a head-up display apparatus 100 is installed in a dashboard of a vehicle 200. The head-up display apparatus 100 emits display light L representing an image toward a windshield 201 which is an example of a projected member of the vehicle 200. The display light L is reflected at the windshield 201 and reaches a viewer 1 (mainly a driver of the vehicle 200). As a result, the head-up display apparatus 100 displays a virtual image V in such a way as to be superimposed on the actual view seen through the windshield 201.

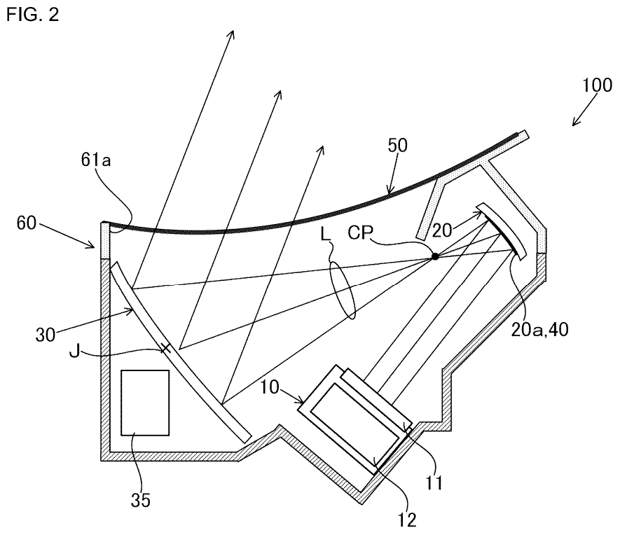

As illustrated in FIG. 2, the head-up display apparatus 100 includes a display device 10, a mirror 20, a concave mirror 30, a mirror drive mechanism 35, and a housing 60.

The display device 10 emits the display light L under control of a control unit (not illustrated). The display device 10 includes a Thin Film Transistor (TFT) liquid crystal display panel 11 and a backlight 12 that illuminates the liquid crystal display panel 11. The display device 10 of the type including the display panel 11 has lower heat resistance than a display device of a type including an organic light-emitting diode (OLED) or a display device of a type that receives reflected light from a digital micromirror device (DMD) and displays an image on a transmission-type screen. Therefore, in the display device 10 of a type including the display panel 11, it is particularly required to suppress a temperature rise of the display panel 11 by a mirror film 40 to be described below.

The concave mirror 30 reflects the display light L reflected by the mirror 20 toward the windshield 201 while enlarging the display light L.

The mirror drive mechanism 35 is configured to be capable of rotating the concave mirror 30 around a rotation axis J extending along a vehicle width direction. When the concave mirror 30 rotates around the rotation axis J, an irradiation position of the display light L with respect to the viewer 1 is adjusted in a height direction.

The housing 60 is formed of a non-translucent resin material or a metal material, and has a hollow substantially rectangular parallelepiped shape. The mirror 20, the concave mirror 30, and the mirror drive mechanism 35 are housed in the housing 60.

The housing 60 has an opening 61a at a position opposing the windshield 201. The housing 60 includes a curved plate-shaped window portion 50 that closes the opening 61a. The window portion 50 is made of a translucent resin material such as acrylic through which the display light L passes.

The housing 60 includes a mirror holder (not illustrated) that houses fixed portions 22L, 22R, and 22C of the mirror 20, which will be described below. In a state where the fixed portions 22L, 22R, and 22C of the mirror 20, which will be described below, are housed in the mirror holder, the fixed portions 22L, 22R, and 22C are biased and fixed by a plate spring (not illustrated).

The mirror 20 is configured as a correction mirror with a reflective polarizing mirror film (cold mirror film), and has a reflective curved surface 20a formed of a free-form surface. The mirror 20 reflects the display light L from the display device 10 toward the concave mirror 30. The mirror 20 has a substantially rectangular plate shape. The reflective curved surface 20a faces the front of the vehicle and obliquely downward. The mirror 20 has a curvature (the reciprocal of a radius of curvature) that causes the reflected display light L to cross vertically at a cross point CP before reaching the concave mirror 30. The mirror 20 has a curvature such that a focal point of the mirror 20 is located on an optical path between the mirror 20 and the concave mirror 30. In other words, a distance from the mirror 20 to the concave mirror 30 is set to be longer than a focal point distance of the mirror 20. The cross point CP is located closer to the mirror 20 than a center position of the optical path between the mirror 20 and the concave mirror 30.

The cross point CP may be located at the center position or may be located closer to the concave mirror 30 than the center position.

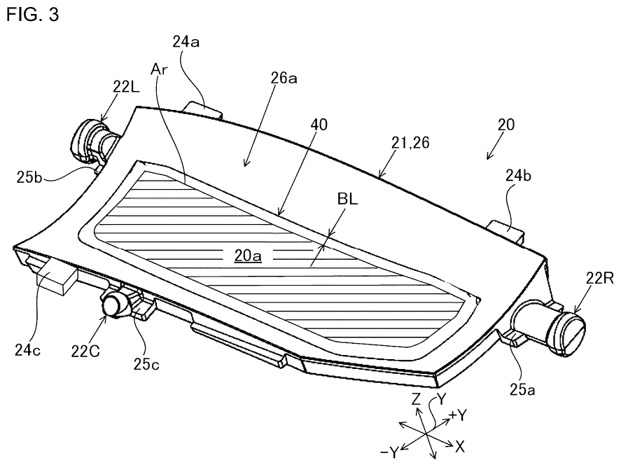

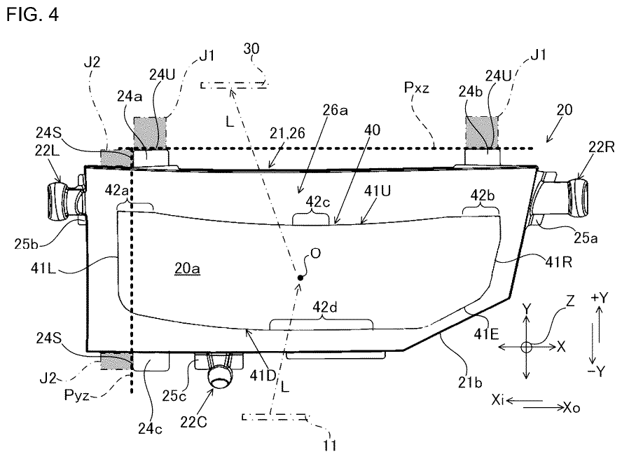

As illustrated in FIGS. 3 and 4, the mirror 20 includes a base material 21 and a visible polarized reflective mirror film 40. The base material 21 includes a base material body portion 26, a plurality of fixed portions 22L, 22R, and 22C, a plurality of reference protrusions 24a, 24b, and 24c, and a plurality of pressed portions 25a, 25b, 25c, and 25d.

In the following description, a longitudinal direction of the mirror 20 is an X direction, a lateral direction of the mirror 20 is a Y direction, and a thickness direction of the mirror 20 is a Z direction. The X direction is a direction corresponding to a left-right direction of the virtual image V as viewed from the viewer 1, i.e., a vehicle width direction, the Y direction is a direction corresponding to an up-down direction of the virtual image V as viewed from the viewer 1, and the Z direction is a direction corresponding to a depth direction of the virtual image V as viewed from the viewer 1. In the following description, left and right are defined as directions when the reflective curved surface 20a of the mirror 20 is viewed from the front.

The base material 21 is integrally formed of a synthetic resin with translucent properties. The base material 21 is formed by injection molding.

The base material body portion 26 has a curved plate shape that is long in the X direction and short in the Y direction. The surface (the surface on a side of the reflective curved surface 20a) of the base material 21 is an attachment surface 26a to which the mirror film 40 is attached. The attachment surface 26a has a convex curved surface in the X direction and a concave curved surface in the Y direction. A height of the surface decreases at both end portions of the attachment surface 26a in the X direction, and the height of the surface gradually increases toward a center portion in the X direction. The height of the surface is the highest at one end portion of the attachment surface 26a in the Y direction (an end portion in the +Y direction in FIG. 3), and the height of the surface gradually decreases toward an other end portion in the Y direction (an end portion in the-Y direction in FIG. 3).

The attachment surface 26a has a substantially rectangular shape that is long in the X direction and short in the Y direction when viewed from the front of the attachment surface 26a. An inclined side portion 21b is formed on a vehicle exterior side Xo (right side in FIG. 4), in the X direction, of a lower side surface of the attachment surface 26a. The vehicle exterior side Xo is defined as a direction viewed from the viewer 1 in the driver's seat. The inclined side portion 21b is inclined upward toward the vehicle exterior side Xo and extends in such a way as to connect a lower side surface and a right side surface of the base material body portion 26. The inclined side portion 21b forms a shape in which a part of the mirror 20 on the vehicle exterior side Xo and on the lower side is cut off, and thus the mirror 20 is prevented from interfering with other members (a duct, etc.) inside the dashboard of the vehicle.

The fixed portions 22L and 22R are located on a left side surface and the right side surface of the base material body portion 26, respectively, and have a substantially cylindrical shape extending in the X direction. The left side surface and the right side surface are located on both sides of the base material 21 in the X direction and extend in the Y direction. The fixed portions 22L and 22R are located at upper-side end portions of the left side surface and the right side surface, respectively, and are arranged coaxially. The fixed portion 22C is located on a lower side surface of the base material 21 and has a substantially spherical shape. The lower side surface is a side surface extending in the X direction. The fixed portion 22C is located closer to a vehicle interior side Xi than the center of the lower side surface in the X direction.

The fixed portions 22L, 22R, and 22C are inserted into a mirror holder (not illustrated) and held in the mirror holder by a plate spring (not illustrated).

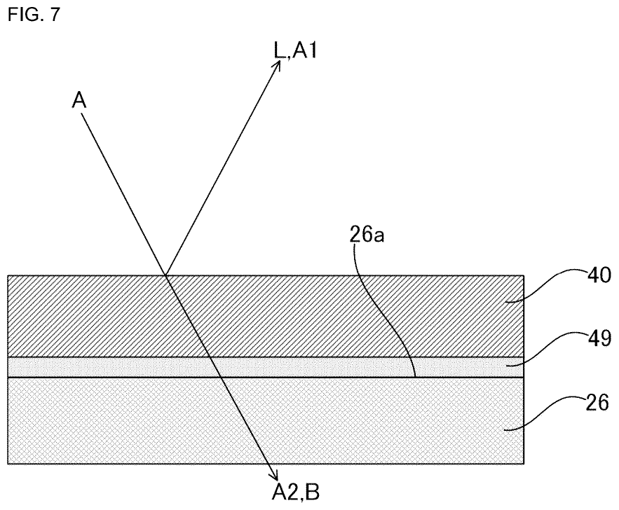

As illustrated in FIG. 7, the mirror film 40 is bonded to the attachment surface 26a of the base material body portion 26 via a transparent adhesive layer 49. The transparent adhesive layer 49 is a transparent optical adhesive layer, for example, an optically clear adhesive (OCA) or an optically clear resin (OCA).

The mirror film 40 is a reflective polarizing multilayer film. The reflective polarizing multilayer film is formed of several hundreds of layers of polyester resin films having different refractive indexes that are laminated on one another.

In the mirror film 40, the refractive index of each film is adjusted in such a way as to reflect only a specific polarized component of visible light A. The mirror film 40 has wavelength-selectivity with respect to reflected wavelengths. In S-polarized light, wavelengths of 780 nm to 2500 nm have a reflectivity of, for example, 20% or less, more preferably 10% or less, for example, about 5%, and wavelengths of 450 nm to 650 nm have a reflectivity of, for example, 80% or more, more preferably 90% or more, for example, 95%.

The mirror film 40 transmits a part of light A2 in the visible light A and infrared light B without reflecting them. The light A2 and the infrared light B are transmitted through the base material body portion 26 with translucent properties and reach the housing 60. For this reason, absorption of the light A2 and the infrared light B in the base material body portion 26 is suppressed, and the temperature of the base material 21 is less likely to rise compared to a black resin-made base material. Therefore, the mirror film 40 is prevented from being peeled off from the base material 21 due to the temperature rise.

Specifically, the mirror film 40 has a reflection axis, and reflects light Al of linearly polarized components parallel to a reflection axis direction (the left-right direction in FIG. 4) in the visible light A. The mirror film 40 is disposed in an orientation in which the reflection axis direction of the mirror film 40 is substantially parallel to the polarization direction of the display light L emitted from the display panel 11. The mirror film 40 does not reflect but transmits the light A2 of linearly polarized components perpendicular to the reflection axis direction in the visible light A.

When the mirror film 40 is disposed as described above, a part of external light such as sunlight (the light A2 in the visible light A and the infrared light B) traveling toward the display panel 11 can be reduced. Therefore, it is possible to suppress the temperature rise of the display panel 11 and reflect the display light L from the display panel 11 while suppressing attenuation of the display light L.

The mirror film 40 is formed in a flexible sheet shape. The mirror film 40 has a flat shape before being attached to the attachment surface 26a, and has a curved shape along the attachment surface 26a in a state of being attached to the attachment surface 26a. The mirror film 40 is formed with an area smaller than that of the attachment surface 26a and is located at the center portion of the attachment surface 26a.

The mirror film 40 is curved so as to form a concave shape in the Y direction and curved so as to form a convex shape in the X direction. The mirror film 40 causes the display light L to vertically cross at a cross point CP before reaching the concave mirror 30, due to the curving of the mirror film 40 in the Y direction. An absolute value of the average curvature of the mirror film 40 in the Y direction is set to be larger than an absolute value of the average curvature of the mirror film 40 in the X direction.

As illustrated in FIG. 4, the mirror film 40 includes an upper side 41U, a lower side 41D, a left side 41L, and a right side 41R as an outer shape of the mirror film 40.

The upper side 41U and the lower side 41D are curved so as to form a U-shape and extend in the X direction. An opening side of the U-shape faces the upper side in the Y direction, i.e., a reflected light traveling side (+Y side). In the U-shape, the upper side 41U and the lower side 41D have a shape in which the valley is deepest at the center portion in the X direction, and a depth of the valley gradually decreases toward both outer sides of the center portion in the X direction.

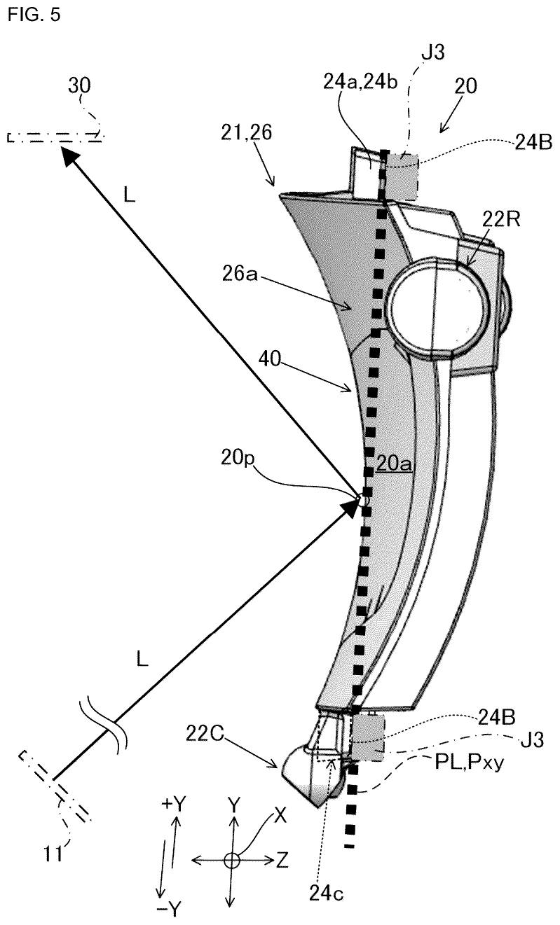

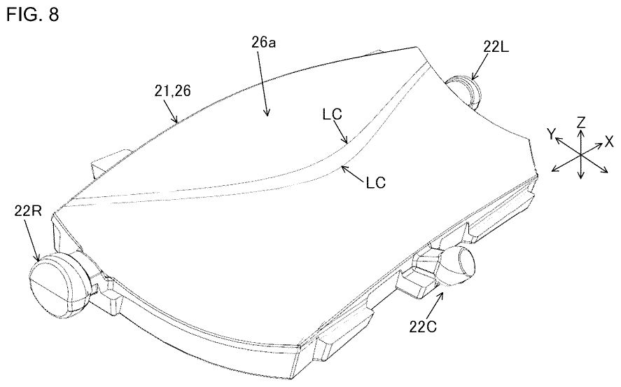

As illustrated in FIG. 8, each contour line LC on the attachment surface 26a of the base material body portion 26 is curved and extends in a U-shape in the X direction, similarly to the upper side 41U. Each contour line LC is a line connecting points having the same height in the Z direction, and as illustrated in FIG. 5, indicates a height with respect to a tangent plane PL that is in contact with a point 20p of the reflective curved surface 20a where an optical axis center (gut ray) of the display light Lis in contact. Since at least a part of the upper side 41U has a shape along the contour line LC, when the mirror film 40 is attached to the reflective curved surface 20a from the upper side 41U, a difference in height on the attachment surface 26a is reduced, and the mirror film 40 is easily attached.

As illustrated in FIG. 4, an inclined side portion 41E along the above-described inclined side portion 21b is formed at a right-side end portion of the lower side 41D.

The left side 41L extends downward from a left end of the upper side 41U and is curved and connected to a left-side end portion of the lower side 41D.

The right side 41R extends downward from a right end of the upper side 41U, and is curved and connected to a right end portion of the inclined side portion 41E.

The upper side 41U has three straight line portions 42a, 42b, and 42c, and the lower side 41D has one straight line portion 42d. Each of the straight line portions 42a to 42d extends linearly in the X direction (the longitudinal direction of the mirror film 40) when the mirror film 40 is not attached to the attachment surface 26a and is flat. The straight line portions 42a to 42d are used for positioning when the mirror film 40 is attached to the attachment surface 26a.

The straight line portion 42a is located at a left end portion of the upper side 41U. The straight line portion 42b is located at a right end portion of the upper side 41U. The straight line portion 42c is located at the center portion of the upper side 41U in the X direction. The straight line portions 42a, 42b, and 42c are connected by curved lines.

The straight line portion 42c is located closer to a center point O (lower side) of the mirror film 40 in the Y direction than the straight line portions 42a and 42b. The straight line portion 42c is set to be shorter in length than the straight line portions 42a and 42b. In this way, by providing the straight line portions 42a, 42b, and 42c at positions parallel to each other and having a step, dimensional measurement accuracy of the mirror film 40 can be enhanced.

The straight line portion 42d is located at the center portion of the lower side 41D in the X direction. The straight line portion 42d is formed longer in length than each of the straight line portions 42a, 42b, and 42c.

The mirror film 40 has a curved shape (curved substantially rectangular shape) curved in a U-shape in the X direction. The curved shape of the mirror film 40 is a shape after warping is applied to the image displayed on the display panel 11 in order to cancel distortion of the virtual image V. This makes it possible to increase the area of the mirror film 40 that is actually used. As illustrated in FIGS. 4 and 5, the mirror film 40 reflects the display light L arriving from a display light arrival side (−Y side), which is the display panel 11 side, to a reflected light traveling side +Z toward the concave mirror 30. The mirror film 40 is disposed so that the opening side of the U-shape faces the reflected light traveling side (+Y side).

The reflective curved surface 20a is formed on the front-side surface (the surface opposite to the base material 21) of the mirror film 40. As illustrated in FIG. 3, the display light L from the display panel 11 enters an incident range Ar of the reflective curved surface 20a. The incident range Ar is formed in a range having a certain margin BL from the outer shape of the mirror film 40. The incident range Ar has a shape similar to the outer shape of the mirror film 40. The margin BL is formed with a length larger than an assumed amount of positional deviation of the incident range Ar.

The plurality of (three) reference protrusions 24a, 24b, and 24c are formed in a convex rectangular parallelepiped shape on the side surface of the base material 21.

The reference protrusions 24a and 24b are located on both sides of the upper side surface of the base material 21 in the X direction. The two reference protrusions 24a and 24b are located so as to overlap each other when viewed from the X direction.

As illustrated in FIG. 4, upper surfaces 24U of the two reference protrusions 24a and 24b are located on a same plane Pxz extending in the XZ plane.

The reference protrusion 24c is located on the lower side surface of the base material 21 and is provided at a position overlapping the reference protrusion 24a when viewed from the Y direction. Side surfaces 24S of the reference protrusions 24a and 24c extending in the Y direction are located on a same plane Pyz extending in the YZ plane.

As illustrated in FIG. 5, rear surfaces 24B of the reference protrusions 24a, 24b, and 24c are located on a same plane Pxy extending in the XY plane. The plane Pxy is the same plane as the tangent plane PL.

When the mirror film 40 is attached to the attachment surface 26a of the base material body portion 26 or when the shape of the reflective curved surface 20a of the mirror 20 is measured, the base material 21 is held by a holding jig (not illustrated) via the reference protrusions 24a, 24b, and 24c.

As illustrated in FIG. 4, a first holding portion J1 of the holding jig is brought into contact with the upper surface 24U of each of the reference protrusions 24a and 24b. Thus, the base material 21 is positioned in the Y direction with high accuracy by the holding jig. Further, a second holding portion J2 of the holding jig is brought into contact with the side surface 24S of each of the reference protrusions 24a and 24c. Thus, the base material 21 is positioned in the X direction with high accuracy by the holding jig.

Further, as illustrated in FIG. 5, a third holding portion J3 of the holding jig is brought into contact with the rear surface 24B of each of the reference protrusions 24a, 24b, and 24c. Thus, the base material 21 is positioned in the Z direction with high accuracy by the holding jig.

Note that the second holding portion J2 may come into contact with a side surface opposite to the side surface 24S of each of the reference protrusions 24a and 24c. In addition, the third holding portion J3 may come into contact with the front surface on the front side of each of the reference protrusions 24a, 24b, and 24c. The third holding portion J3 may be in contact with the rear surfaces 24B or the front surfaces of two of the three reference protrusions 24a, 24b, and 24c.

The reference protrusion 24c is located closer to the vehicle interior side Xi than the center of the lower side surface of the base material 21 in the X direction. Specifically, the reference protrusion 24c is located at an end portion of the lower side surface of the base material 21 on the vehicle interior side Xi. The vehicle interior side Xi is the right side as viewed from the driver in a case of a left-hand drive vehicle, and is the left side as viewed from the driver in a case of a right-hand drive vehicle. The reference protrusion 24c is formed on the vehicle interior side Xi because the vehicle interior side Xi has a spatial margin as compared with the vehicle exterior side Xo.

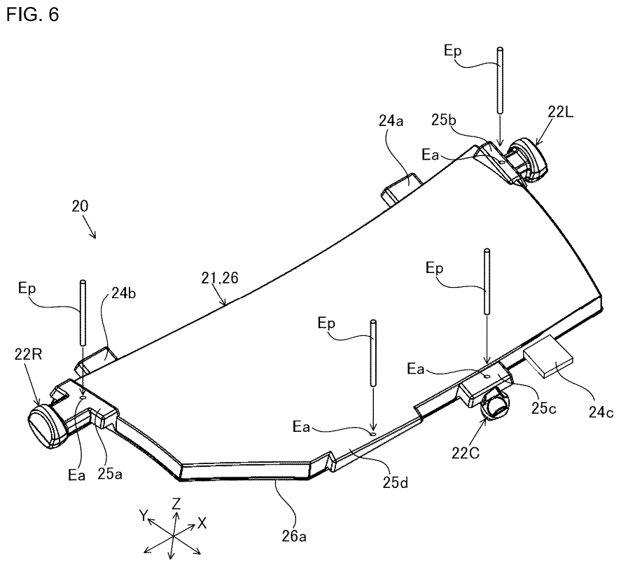

As illustrated in FIG. 6, the plurality of pressed portions 25a to 25d are formed as rectangular parallelepipeds around the base material 21.

The plurality of pressed portions 25a to 25d are parts pressed by an eject pin Ep at a time of injection-molding. A circular mark Ea of the eject pin Ep is formed on a rear surface of each of the pressed portions 25a to 25d.

The pressed portion 25a is located at a base portion of the fixed portion 22R on the right side surface of the base material 21. The pressed portion 25a has a rectangular parallelepiped shape long in the Y direction.

The pressed portion 25b is located at a base portion of the fixed portion 22L on the left side surface of the base material 21. The pressed portion 25b has a rectangular parallelepiped shape long in the Y direction.

The pressed portion 25c is located at a base portion of the fixed portion 22C on the lower side surface of the base material 21. The pressed portion 25c has a rectangular parallelepiped shape long in the X direction.

The pressed portion 25d is located on the lower side surface of the base material 21 and has a rectangular parallelepiped shape long in the X direction. The pressed portion 25d is provided at a position away from the fixed portions 22L, 22R, and 22C.

The pressed portions 25a to 25d may be held by a holding jig in the same manner as the reference protrusions 24a, 24b, and 24c.

### Effects

According to the embodiment described above, the following effects are achieved.

(1-1) The mirror 20 has the reflective curved surface 20a that reflects the display light L. The mirror 20 includes: the base material 21 with the attachment surface 26a forming a curved surface; and the mirror film 40 that forms the reflective curved surface 20a in a state of being bonded to the attachment surface 26a, that reflects light of polarized components corresponding to the display light L in the visible light A, and that transmits the infrared light B.

According to this configuration, the mirror 20 can be easily manufactured by attaching the mirror film 40 to the attachment surface 26a forming a curved surface.

In addition, due to properties of the mirror film 40, it is possible to suppress reflection of unnecessary external light toward the display panel 11 and thus to suppress the temperature rise of the display panel 11.

(1-2) The base material 21 is formed of a synthetic resin with translucent properties.

According to this configuration, light that has passed through the mirror film 40 is prevented from passing through the base material 21 and being absorbed by the base material 21. Therefore, a temperature rise of the base material 21 can be suppressed, and the mirror film 40 is prevented from being peeled off from the attachment surface 26a.

In addition, when the base material 21 is made of glass, it is difficult to form the attachment surface 26a as a curved surface. However, when the base material 21 is made of synthetic resin, a flexible shape can be achieved by injection-molding, and thus it is easy to form the attachment surface 26a as a curved surface.

(1-3) The reflective curved surface 20a is a convex curved surface in the X direction, which is an example of a first direction, and is a concave curved surface in the Y direction, which is an example of a second direction. The outer shape of the mirror film 40 is a U-shape curved in the X direction.

According to this configuration, the mirror film 40 can be easily attached to the reflective curved surface 20a. In particular, when the mirror film 40 is attached, the center portion of the mirror film 40 in the X direction is less likely to be wrinkled, and thus the mirror film 40 has excellent manufacturability.

(1-4) In the reflective curved surface 20a, a tangent plane PL, which is in contact with a point 20p corresponding to the optical axis center of the display light L, is set as a reference plane. When a contour line LC indicating a height with respect to the tangent plane PL is drawn on the reflective curved surface 20a, at least a part of the upper side 41U of the outer shape of the mirror film 40 extends along a part of the contour line LC.

According to this configuration, since a part of the mirror film 40 is attached along the contour line LC, it is easy to attach the mirror film 40 to the reflective curved surface 20a.

(1-5) The incident range Ar on which the display light Lis incident is formed on the reflective curved surface 20a. The outer shape of the mirror film 40 is formed in a shape having a certain margin BL around the incident range Ar.

According to this configuration, the mirror film 40 has an outer shape corresponding to the incident range Ar, and the mirror film 40 is prevented from becoming unnecessarily large.

(1-6) The mirror 20 reflects the display light L toward the reflected light traveling side (+Y side) in the Y direction. The outer shape of the mirror film 40 is a shape curved in the X direction in such a way as to form a U-shape that opens to the reflected light traveling side (+Y side).

According to this configuration, the area of the mirror film 40 can be more efficiently used as a reflection region.

(1-7) The outer shape of the mirror film 40 has the upper side 41U, which is an example of a first side, and the lower side 41D, which is an example of a second side, extending in parallel in the X direction. The upper side 41U includes two straight line portions 42a and 42b, which are an example of a first straight line portion, located at both ends in the X direction. The lower side 41D includes a straight line portion 42d, which is an example of a second straight line portion, located at the center in the X direction. The straight line portions 42a, 42b, and 42d form a straight line extending in the longitudinal direction (X direction) of the mirror film 40 in a state in which the mirror film 40 is peeled off from the attachment surface 26a and flattened.

According to this configuration, the mirror film 40 can be attached to the attachment surface 26a with high positional accuracy by using the straight line portions 42a, 42b, and 42d.

(1-8) The outer shape of the mirror film 40 has the upper side 41U and the lower side 41D extending in parallel in the X direction. The upper side 41U has a shape including curved lines and the straight line portions 42a, 42b, and 42c. The curved line is provided so as to be interposed between two straight line portions 42a to 42c provided at positions shifted from each other in the Y direction orthogonal to the X direction.

According to this configuration, by forming the straight line portions 42a, 42b, and 42c which are parallel to each other at different levels instead of forming a continuous curved line, the dimension measurement accuracy is improved. Further, the mirror film 40 can be attached to the attachment surface 26a with high positional accuracy by using the straight line portions 42a, 42b, and 42c.

(1-9) The head-up display apparatus 100 includes the mirror 20, the display device 10 that radiates the display light L, and the concave mirror 30 that reflects the display light L reflected by the mirror 20. The mirror 20 causes the reflected display light L to cross in the up-down direction at a cross point CP before reaching the concave mirror 30. The cross point CP is located closer to the mirror 20 than the concave mirror 30.

According to this configuration, since the cross point CP approaches the mirror 20, it is possible to reduce the size of the mirror 20, which is highly difficult to manufacture.

(2-1) The mirror 20 reflects the display light L and has the reflective curved surface 20a forming a curved surface. The mirror 20 includes: the base material 21 with the attachment surface 26a forming a curved surface; the mirror film 40 that forms the reflective curved surface 20a in a state of being bonded to the attachment surface 26a; and the reference protrusions 24a, 24b, and 24c, which are examples of first to third reference protrusions formed to protrude around the base material 21. Each of the reference protrusions 24a, 24b, and 24c includes the upper surface 24U and the side surface 24S, which are examples of first and second surfaces. The upper surfaces 24U of the reference protrusions 24a and 24b are located on the same plane Pxz, which is an example of a first plane. The side surfaces 24S of the reference protrusions 24a and 24c are located on the same plane Pyz, which is an example of a second plane. The planes Pxz and Pyz are virtual planes orthogonal to each other.

The mirror 20 having the reflective curved surface 20a is required to have high molding accuracy. However, as compared with a vapor-deposited mirror, the mirror 20 in which the reflective curved surface 20a is formed by attaching the mirror film 40 is subjected to a load due to the attachment of the mirror film 40, and there is a possibility that shape accuracy of the reflective curved surface 20a is relatively lowered.

In this regard, according to the above-described configuration, the mirror film 40 is attached in a state where the base material 21 is positioned by using the reference protrusions 24a, 24b, and 24c, and thus it is possible to increase the shape accuracy of the reflective curved surface 20a. In this positioned state, the shape of the reflective curved surface 20a can be measured with high accuracy.

(2-2) The reference protrusion 24c is located on the lower side surface of the base material 21, and is located closer to the vehicle interior side Xi than the center of the lower side surface in the vehicle width direction (X direction).

According to this configuration, since the vehicle interior side Xi in the vehicle width direction has a relatively larger space margin than the vehicle exterior side Xo in the vehicle width direction, it is suitable as a position at which the reference protrusion 24c is provided.

(2-3) Each of the reference protrusions 24a, 24b, and 24c includes a rear surface 24B, which is an example of a third surface. The rear surfaces 24B of the reference protrusions 24a, 24b, and 24c are located on the same plane Pxy, which is an example of a third plane. The rear surface 24B includes a point 20p corresponding to the optical axis center of the display light L in the reflective curved surface 20a.

According to this configuration, the mirror film 40 is attached in a state where the base material 21 is positioned by using the reference protrusions 24a, 24b, and 24c, and thus it is possible to increase the shape accuracy of the reflective curved surface 20a. In this positioned state, the shape of the reflective curved surface 20a can be measured with high accuracy.

(2-4) The mirror film 40 transmits a part of the visible light A. The base material 21 is translucent. The mirror 20 includes the pressed portions 25a to 25d formed around the base material 21 and each having a mark Ea of the eject pin Ep.

According to this configuration, the pressed portions 25a to 25d having the marks Ea are formed around the base material 21, thereby making it possible to suppress the mark Ea from being illuminated by the visible light A transmitted through the mirror film 40 and to suppress the occurrence of stray light.

In addition, the pressed portions 25a to 25d can also serve as surfaces to be placed on a holding jig when the mirror film 40 is attached.

(2-5) The mirror 20 includes the fixed portions 22L, 22R, and 22C, which are formed in a convex shape on the side surface of the base material 21 and are fixed to a mirror holder (not illustrated) that is an example of a fixing object. The pressed portions 25a to 25d are formed at bases of the fixed portions 22L, 22R, and 22C. According to this configuration, even when the pressed portions 25a to 25d are pressed by the eject pin Ep, the fixed portions 22L, 22R, and 22C disperse forces. Therefore, the attachment surface 26a is less likely to be deformed, and the accuracy of the reflective curved surface 20a can be increased.

### Modification

Note that the above-described embodiment can be implemented in the following forms obtained by appropriately modifying the embodiment.

In the above-described embodiment, the concave mirror 30 may be omitted.

In the above-described embodiment, the mirror drive mechanism 35 may be omitted.

In the above-described embodiment, the number or positions of the straight line portions 42a to 42d can be changed as appropriate. In addition, the straight line portions 42a to 42d may be omitted, and the upper side 41U and the lower side 41D may be formed as curved lines over the entire region.

In the above-described embodiment, the head-up display apparatus 100 is mounted on the vehicle 200, but may be mounted on a vehicle such as an airplane or a ship other than the vehicle 200. Further, the projection member is not limited to a front windshield, and may be a dedicated combiner.

In the above-described embodiment, the number, positions, or shapes of the fixed portions 22L, 22R, and 22C can be changed as appropriate.

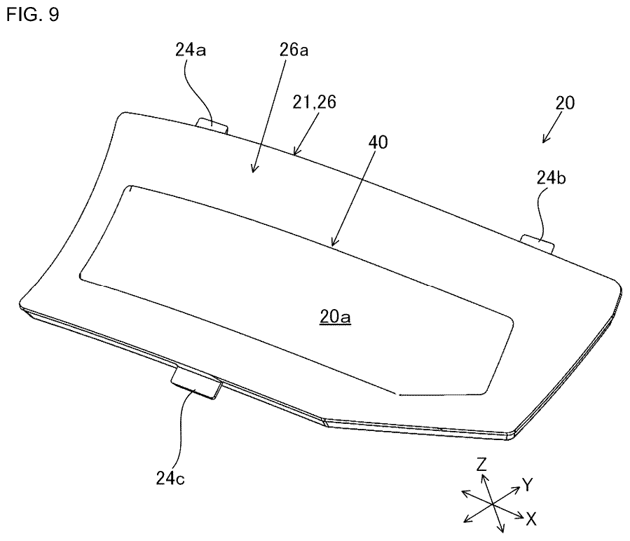

As illustrated in FIG. 9, the fixed portions 22L, 22R, and 22C may be omitted.

The number, positions, or shapes of the pressed portions 25a to 25d in the above-described embodiment can be changed as appropriate. Further, the pressed portions 25a to 25d in the above-described embodiment may be omitted. In addition, a pressed portion which is pressed by the eject pin Ep may be formed on the rear surface of the base material 21 and on the outer peripheral side of the reflective curved surface 20a.

In the above-described embodiment, the base material 21 is not limited to a synthetic resin, and may be made of glass as long as it is translucent.

Further, in the above-described embodiment, in the base material 21, only the base material body portion 26 may be formed of a synthetic resin with translucent properties, and the fixed portions 22L, 22R, and 22C, the reference protrusions 24a, 24b, and 24c, and the pressed portions 25a to 25d may be formed of a material having light shielding properties. In addition, the entire base material 21 may be formed of a material having light shielding properties. In the above-described embodiment, similarly to the upper side 41U, the lower side 41D may be constituted by three straight line portions 42a to 42c and curved lines between the straight line portions 42a to 42c.

In the above-described embodiment, the mirror film 40 has a U-shape curved in the X direction. However, the mirror film 40 may have a rectangular shape elongated in the X direction as long as the shape includes the incident range Ar.

Although the mirror film 40 is attached to a central region of the surface of the base material 21, the mirror film 40 may be attached over the entire surface of the base material 21.

In the above-described embodiment, the curved shape of the attachment surface 26a can be changed as appropriate. Although the mirror 20 forms a cross optical path, the mirror 20 may have a shape of the reflective curved surface 20a which does not form a cross optical path. Further, the attachment surface 26a may have a concave or convex curved surface in only one of the X direction and the Y direction.

In the above-described embodiment, at least a part of the upper side 41U has a shape along the contour line LC, but at least a part of the lower side 41D may have a shape along the contour line LC. In addition, at least a part of both the upper side 41U and the lower side 41D may have a shape along the contour line LC. That is, in this case, the outer shape of the mirror film may be a shape (a drum-like shape or an hourglass-like shape) which spreads in both directions, in a predetermined direction.

The mirror film 40 may be a film other than the reflective polarizing film.

In the above-described embodiment, the display device 10 is a type including the display panel 11, but is not limited thereto, and may be any type as long as the display light L can be radiated from the display surface. The display device 10 may be, for example, a type including an OLED or a type that receives reflected light from a DMD and displays an image on a transmission-type screen, or the like.

### REFERENCE SIGNS LIST

1 Viewer
10 Display device
11 Display panel
12 Backlight
20 Mirror
20a Reflective curved surface
20p Point
21 Base material
21b Inclined side portion
22C, 22L, 22R Fixed portion
24a, 24b, 24c Reference protrusion
24B Rear surface
24S Side surface
24U Upper surface
25a-25d Pressed portion
26 Base material body portion
26a Attachment surface
30 Concave mirror
35 Mirror drive mechanism
40 Mirror film
41U Upper side
41D Lower side
41L Left side
41R Right side
41E Inclined side portion
42a-42d Straight line portion
49 Transparent adhesive layer
50 Window portion
60 Housing
61a Opening
100 Head-up display apparatus
200 Vehicle
201 Windshield
A Visible light
A1, A2 Light
B Infrared light
J Rotation axis
J1-J3 First to third holding portions
L Display light
O Center point
V Virtual image
BL Margin
LC Contour line
CP Cross point
PL Tangent plane
Ea Mark
Ar Incident range
Ep Eject pin
Xi Vehicle interior side
Xo Vehicle exterior side
Pxz, Pyz, Pxy Plane

1. A mirror having a reflective curved surface that reflects display light, the mirror comprising:
a base material with an attachment surface forming a curved surface;
a mirror film that forms the reflective curved surface in a state of being bonded to the attachment surface; and
first to third reference protrusions formed to protrude around the base material, wherein
the first to third reference protrusions each include a first surface and a second surface,
the first surfaces of the first and second reference protrusions are located on a same first plane,
the second surfaces of the first and third reference protrusions are located on a same second plane, and
the first and second planes are virtual planes orthogonal to each other.

2. The mirror according to claim 1, wherein
the third reference protrusion is located on a lower side surface of the base material, and is located closer to a vehicle interior side in a vehicle width direction than a center of the lower side surface in the vehicle width direction.

3. The mirror according to claim 1, wherein
the first to third reference protrusions each include a third surface,
the third surfaces of the first to third reference protrusions are located on a same third plane, and
the third surface includes, in the surface, a point of the reflective curved surface where an optical axis center of the display light reaches.

4. The mirror according to claim 1, wherein
the mirror film transmits a part of visible light,
the base material is translucent, and
the mirror includes a pressed portion formed around the base material and having a mark of an eject pin.

5. The mirror according to claim 4, comprising
a fixed portion formed in a convex shape on a side surface of the base material and fixed to a fixing object, wherein
the pressed portion is formed at a base of the fixed portion.

6. A head-up display apparatus comprising:
the mirror according to claim 1; and
a display device that radiates the display light to the mirror.
